(19) United States
(12) Patent Application Publication
(10) Pub. No.: US 2025/0129616 A1
(43) Pub. Date: Apr. 24, 2025

(54) ROTATING T-CLIP AND METHODS OF USE

(71) Applicant: Grabber Construction Products, Inc., Highland, UT (US)

(72) Inventors: Andrew E. Reed, Trumbull, CT (US); Christopher D. Hageman, Glastonbury, CT (US); David Mathieu, Ocala, FL (US); Jason Roxburgh, Lake Wylie, SC (US)

(21) Appl. No.: 18/924,825

(22) Filed: Oct. 23, 2024

Related U.S. Application Data
(60) Provisional application No. 63/592,755, filed on Oct. 24, 2023.

(51) Int. Cl. E04F 15/02

(52) U.S. Cl. CPC E04F 15/02044; E04F 15/02183

(57) ABSTRACT

Rotating T-clips, installation tools, and methods of use in the installation of decking to achieve consistent board spacing and installation height. T-clips may comprise a wing element, collar element, and fastener element assembled for insertion in a gap between adjacent deck boards. The wing element, once descended beyond the gap opening into recessed spaces beneath the deck surface, naturally rotate by the motion of a driving means until engaging elements connect with surfaces of the spaces.

### CROSS-REFERENCE TO RELATED APPLICATIONS

This application claims the benefit of U.S. Prov. Pat. App. Ser. No. 63/592,755, filed Oct. 24, 2023, the entire of which is incorporated herein by reference.

### BACKGROUND OF THE INVENTION

### Field of the Invention

This disclosure is related to the field of construction, and more particularly to a hidden fastener system for rapid installation of decking.

### Description of the Related Art

Residential decks serve as versatile outdoor living spaces that provide numerous functions, uses, and benefits to homeowners. They serve as extensions of the indoor living area, allowing people to enjoy the outdoors comfortably. Decks are commonly used for various activities such as hosting gatherings, barbecues, relaxing, and spending quality time with family and friends. They offer a designated space for outdoor furniture, plants, and décor, allowing homeowners to create a personalized and inviting outdoor oasis. Residential decks also provide an excellent vantage point to appreciate the surrounding landscape and enjoy fresh air. Additionally, decks can increase the overall value of a property, enhance its curb appeal, and provide a desirable feature for potential buyers. Their popularity stems from the fact that they offer a convenient and enjoyable way to expand living space, connect with nature, and create a seamless transition between indoor and outdoor areas.

The installation process of a residential deck typically involves clearing the area where the deck will be installed of vegetation or debris, leveling the ground, and setting footings or piers to establish a foundation. The footings support the deck's weight and lend structural stability by transmitting loads to the Earth. Once the footings are placed, vertical posts are installed, and beams are attached to the posts to create the framework of the deck. Joists are then attached to the beams to form a base for the deck surface, which are then attached to the base by installing the decking—usually planks of treated lumber or composite materials-on the joists. Finally, railings, stairs, and decorative features may be added.

This process, though simple in concept, can be challenging, time-consuming, and expensive. Precise measurements are required, along with accurate leveling, structural calculations, and proper use of construction techniques to ensure safety and stability. The installation of the deck surface, whether lumber or composite materials, often involves cutting, fitting, and fastening numerous boards, a demanding and time-consuming process. Installing the actual decking can be challenging due to several factors. Ensuring proper alignment and spacing of the deck planks requires precise measurement and attention to detail to ensure consistency and an aesthetically pleasing appearance. Also, fastening the deck boards securely is important to stability and longevity, and may require specialized tools or equipment. Ensuring that the fasteners are correctly driven into the appropriate locations without damaging the boards or fasteners is a precise operation, especially when dealing with different board lengths and angles, and if the installer is not careful, the fasteners may be misaligned with the underlying joists and miss them entirely. This work is often done while working high above the ground, where workers' attention is focused elsewhere, increasing fall risk.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, are rotating T-clips, installation tools, and methods of use in the installation of decking to achieve consistent board spacing and installation height. At a high level of generality, the T-clips comprise a wing element, collar element, and fastener element, which are assembled for insertion in the gap between adjacent deck boards. Once the wing element has descended beyond the gap and into the recessed spaces beneath the deck boards surface, the wing element is naturally rotated by the rotational motion of a driving means (e.g., a drill) until engaging elements (e.g., teeth) connect with the surfaces of the recessed spaces. The collar element then experiences partial compression as the fastener is driven between the deck boards, achieving a clean, aesthetically pleasing look. An installation tool may be used to assist with spacing of the deck boards and rapid loading and deployment of the rotating T-clips in succession for speed and efficiency. These and other elements are described in further detail herein.

Described herein, among other things, is a rotating T-clip comprising: a fastener element; a wing element comprising: a pair of opposing wings extending outwardly from a center thereof; and a vertical bore extending generally perpendicularly and centrally from a top side to an opposing bottom side of the wing element; and a collar element comprising: a main body; and a pair of connecting elements, each of the connecting elements affixed to the main body via an arm.

In an embodiment of the rotating T-clip, the top surface is generally flat.

In another embodiment of the rotating T-clip, the vertical bore comprises a pair of opposing retaining elements disposed on an utter periphery thereof.

In another embodiment of the rotating T-clip, the retaining elements comprise recesses.

In another embodiment of the rotating T-clip, the wing element has a cross-section generally in the configuration of an upside-down U-shape.

In another embodiment of the rotating T-clip, the bottom edge of the wing element tapers upward toward the top surface at opposing distal ends.

In another embodiment of the rotating T-clip, each of the wings is generally symmetric across a major axis of the wing element.

In another embodiment of the rotating T-clip, the wings are generally colinear along the major axis.

In another embodiment of the rotating T-clip, each of the wings comprises at least one engaging element.

In another embodiment of the rotating T-clip, the engaging element comprises a generally triangular tooth.

In another embodiment of the rotating T-clip, wherein the each of the teeth protrudes from the bottom edge.

In another embodiment of the rotating T-clip, the main body of the collar element is generally in the configuration of a hollow cylinder.

In another embodiment of the rotating T-clip, the hollow cylinder has an outer diameter less than an inner diameter of the vertical bore.

In another embodiment of the rotating T-clip, the hollow cylinder has a pair of opposing truncated chords on an outer surface.

In another embodiment of the rotating T-clip, the connecting elements are generally in the configuration of an inverted L-shape.

In another embodiment of the rotating T-clip, the connecting elements extend radially outward from a central axis of the collar element.

In another embodiment of the rotating T-clip, the arms are connecting elements extending radially outward from a central axis of the collar element.

In another embodiment of the rotating T-clip, the rotating T-clip is in an assembled configuration.

In another embodiment of the rotating T-clip, in the assembled configuration, the portion of each of the connecting elements is received within and held by one of the retaining elements and a second portion of each of the connecting elements is braced against the top surface.

A clip strip comprising a plurality of any of the foregoing rotating T-clip assemblies removably disposed on a linear backing.

### BRIEF DESCRIPTION OF THE DRAWINGS

FIG. 1 provides an isometric cutaway view of an embodiment of the rotating T-clip assembly according to the present disclosure.

FIGS. 2A, 2B, 2C, 2D, and 2E provide various views of a wing element for a rotating T-clip assembly according to the present disclosure.

FIGS. 3A, 3B, and 3C provide various views of a collar element for use with a rotating T-clip assembly according to the present disclosure.

FIG. 4 provides a side elevation cutaway view of a T-clip assembly according to the present disclosure in use with decking materials.

FIG. 5 depicts a method of using a rotating T-clip assembly according to the present disclosure with decking materials.

FIGS. 6A, 6B, 6C, 6D, 6E, 6F, and 6G provide various elevation and isometric views of an embodiment of a rotating T-clip assembly according to the present disclosure, in assembled configuration.

FIGS. 6H, 6I, 6J, and 6K provide various elevation and isometric views of an embodiment of a rotating T-clip assembly according to the present disclosure, in exploded configuration.

FIG. 7 provides a perspective and detail view of an embodiment of a rotating T-clip assembly clip according to the present disclosure.

FIG. 8 provides perspective and detail views of an embodiment of a rotating T-clip assembly clip according to the present disclosure.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Described herein, among other things, are rotating T-clips, installation tools, and methods of use in the installation of decking to achieve consistent board spacing and installation height. At a high level of generality, the T-clips comprise a wing element, collar element, and fastener element, which are assembled for insertion in the gap between adjacent deck boards. Once the wing element has descended beyond the gap and into the recessed spaces beneath the deck boards surface, the wing element is naturally rotated by the rotational motion of a driving means (e.g., a drill) until engaging elements (e.g., teeth) connect with the surfaces of the recessed spaces. The collar element then experiences partial compression as the fastener is driven between the deck boards, achieving a clean, aesthetically pleasing look. An installation tool may be used to assist with spacing of the deck boards and rapid loading and deployment of the rotating T-clips in succession for speed and efficiency. These and other elements are described in further detail herein.

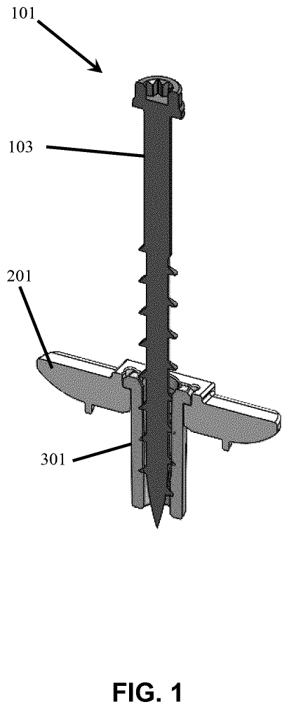

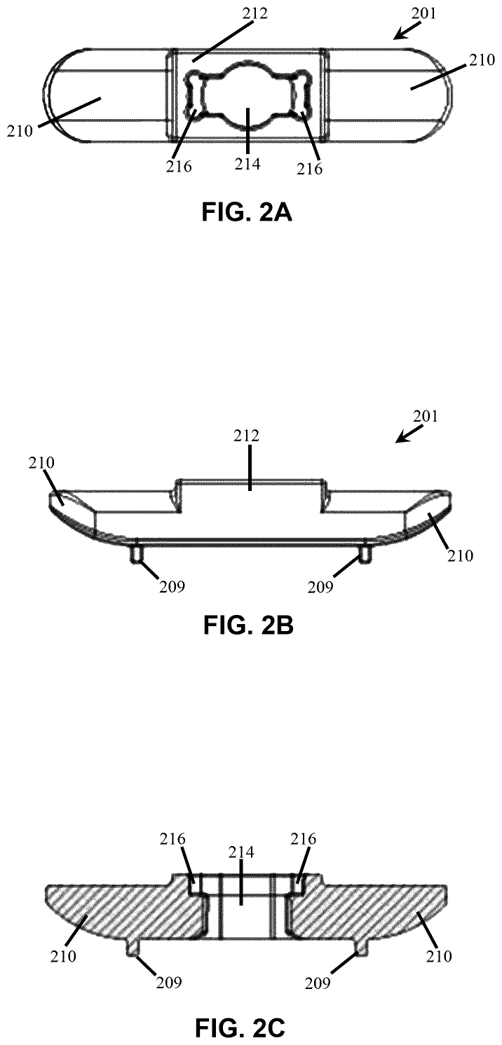

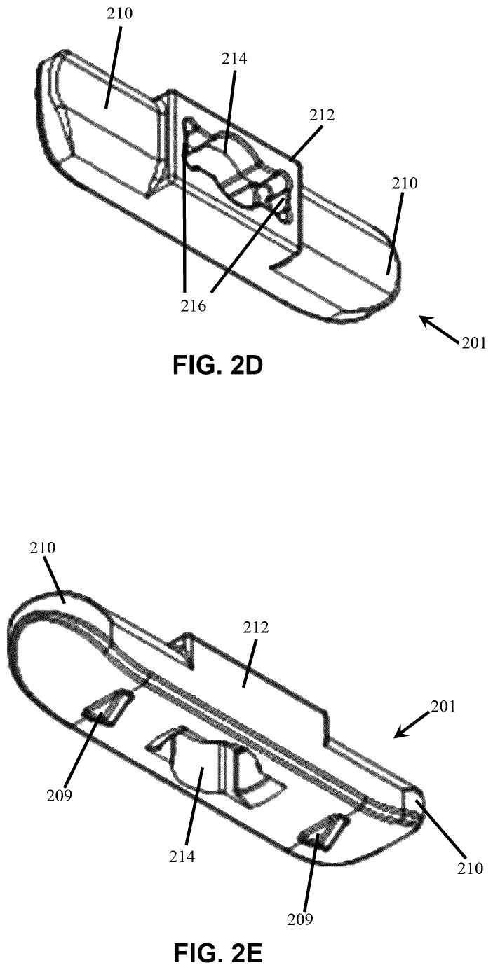

FIG. 1 depicts a cross-sectional view of a non-limiting, exemplary embodiment of a rotating T-clip assembly (101) according to the present disclosure. The depicted rotating T-clip assembly (101) comprises a wing element (201), a collar element (301), and a fastener element (103). FIGS. 2A, 2B, 2C, 2D, and 2E show alternative views of the embodiment (101). The depicted wing element (201) of these FIGs. comprises a center body (212) having a pair of wings (210) extending outward from the center body (212) in opposing directions. The depicted main body (212) comprises a vertical bore (214) or aperture (214) extending generally perpendicularly and centrally therethrough, from a top side to an opposing bottom side. The depicted aperture (214) is sized and shaped to receive a fastener element (103). In this embodiment, the aperture (214) has a variable diameter, with the top of the aperture (214) being wider than the central column of the aperture (214), thereby providing a base, ledge, or lip (216) at the outer perimeter, also referred to herein as a retaining element (216), which may receive or retain the collar element (301) as described elsewhere herein.

The depicted wings (210) of this embodiment have a generally flat or planar top surface, and a partially flat bottom surface which tapers upward towards the outer edge of the wings (210), giving the side cross-section of each wing (210) the general impression of the bottom of a boat hull or pontoon. This contour is clearly shown in, for example, FIGS. 2B and 2C, and may correspond to the shape of a recess (403) in the deck boards (401) with which the rotating T-clip assembly (101) will be used. The contoured shape may prevent or reduce the tips of the wings (210) from making unwanted, unintended, or premature contact with the recesses (403) of the deck boards (401) during installation, as described elsewhere herein.

In the depicted embodiment, the wings (210) are generally symmetric and protrude from the main body (212) such that the major axes of the wings (210) are colinear (e.g., at a 180° angle from one another), but in an alternative embodiment, different configurations may be possible. For example, in an embodiment intended for use with deck boards (401) installed at corner or non-parallel angle, the wings (210) may not be colinear, and may instead be disposed at a different angle to accommodate the installation angle of the associated deck boards (401).

In the depicted embodiment, the rotating T-clip assembly (101) comprises two wings (210), but in an alternative embodiment, more or fewer wings (210) may be used. In the immediately prior example of deck boards (401) attached at a non-parallel angle, using just two wings (210) may make installation more difficult because the rotational motion of the two wings (210) during installation may result in the wings (210) being disposed in an ineffective location relative to the recesses (403) of the deck boards (401) and thus fail to properly engage. By including more than two wings (210), proper engagement is more likely. Thus, an alternative embodiment may include three or more wings (210), depending on the needs of the embodiment. Likewise, there may be use cases for a wing element (201) having only one wing (210), such as an edge installation where there is a single deck board (401) having a recess (403) adjacent to an element which lacks such a recess.

The depicted wings (210) each further comprise at least one engaging element (209). In this depicted embodiment, the engaging element (209) is generally in the configuration of a thin, triangular tooth projecting from the bottom of the wing (210). The engaging element (209) is generally sized, shaped, and positioned so that when the rotating T-clip assembly (101) is installed, the engaging elements (209) connect with the bottom surface (405) of the recesses (403) of the deck boards (401), and “dig in” or engage the surface (405) to establish a firm connection to hold the deck boards (401) in place, as described elsewhere herein.

In this depicted embodiment, each wing (210) has one engaging element (209) disposed on the bottom side of the wing (210) at about half the distance to the tip, and positioned just before the point where the bottom contour begins to taper. This causes the engaging element (209), and not the bottom of the wing (210), to engage with the recess surface (405). Applying this principle, other configurations are also possible, and may vary depending on the size and shape of the wing (210), the size, shape, and placement of the engaging element (209), and the configuration of the recess (403).

It should be noted that although the depicted embodiment comprises one engaging element (209) per wing (210), in alternative embodiments, different configurations may be used. For example, multiple engaging elements (209) may be disposed on a given wing (210), which may have differing sizes, shapes, and configurations. Likewise, in an embodiment, one or more wings (210) may lack an engaging element (209), as shown in an alternative embodiment described elsewhere herein.

Because the depicted wing element (201) engages with and holds the deck boards (401) in place, it is preferably constructed of a resilient, weather-resistant material that is not prone to easy breakage or deformity. The wing element (201) will thus generally be made of a hardened steel, and/or other metal alloys, and may include a protective finish to prolong life.

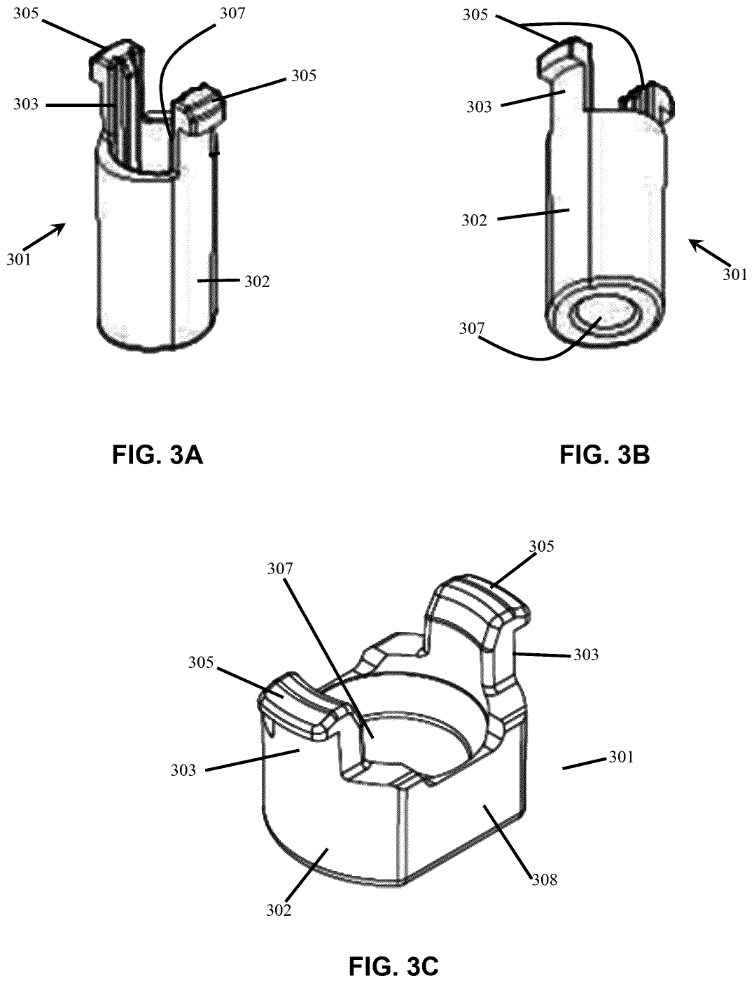

FIGS. 3A, 3B, and 3C depict various exemplary embodiments of a collar element (301) according to the present disclosure. In the depicted embodiments, the collar element (301) comprises a main body (302), and connecting elements (305) attached to the main body (302) via arms (303). The depicted main body (302) of FIGS. 3A and 3B is generally in the configuration of a hollow cylinder having an outer diameter about the same, but slightly less, than the inner diameter of the main column of the aperture (214) through the wing element (201), allowing the main body (302) of the collar element (301) to be easily inserted through the aperture (214) to achieve a snug fit with minimal play. The main body (302) of FIG. 3C has a pair of parallel truncated chords (308) on lateral outer surfaces, which facilitate gripping. The diameter of the hollow interior (307) will generally correspond to that of the fastener element (103), which will be inserted through the collar element (301) during installation, as described elsewhere herein.

The depicted connecting elements (305) extend radially outward from the central axis of the collar element (301) a short distance, and have a flat bottom surface (304). The width of these depicted connecting elements (305) as measured from the outer surface of the main body (302) to the farthest extent of the connecting elements (305) is about the same as, but slightly less than, the additional radius of the retaining elements (216). Further, the dimensions and shape of these depicted connecting elements (305) generally compared to those and the retaining elements (216), allowing the connecting elements (305) to be received in the retaining elements (216) and held therein. In an embodiment, these components (201) and (301) are configured for a snap-in fit. This prevents the collar element (301), when installed in the wing element (201), from sliding through the aperture (214) and becoming disconnected.

The fastener element (103) may be any suitable fastener for affixing the rotating T-clip assembly (101) to a joist (407) or other decking structure. Generally, the fastener element (103) will be a long, threaded screw suitable for use in decking and having weather-resistant properties. Such fasteners are known in the art. The size and length of the fastener element (103) and, if applicable, the configuration of its threads, will depend on the particular embodiment, but generally the diameter of the fastener element (103), excluding the threads, will be about the same as, but slightly less than, the diameter of the hollow inner column of the collar element (301), and the diameter of the threads will be slightly larger than that diameter, but slightly less than the inner diameter of the main column of the aperture (214) in the wing element (201). This is because the wing element (201) will generally be constructed of a hard steel, metal alloy, or other material resistant to deformation, whereas the collar element (301) will generally be constructed of a plastic or other material susceptible to some deformation. Thus, the threads preferably clear the internal diameter of the wing aperture (214), but engage the inner diameter of the collar aperture (307).

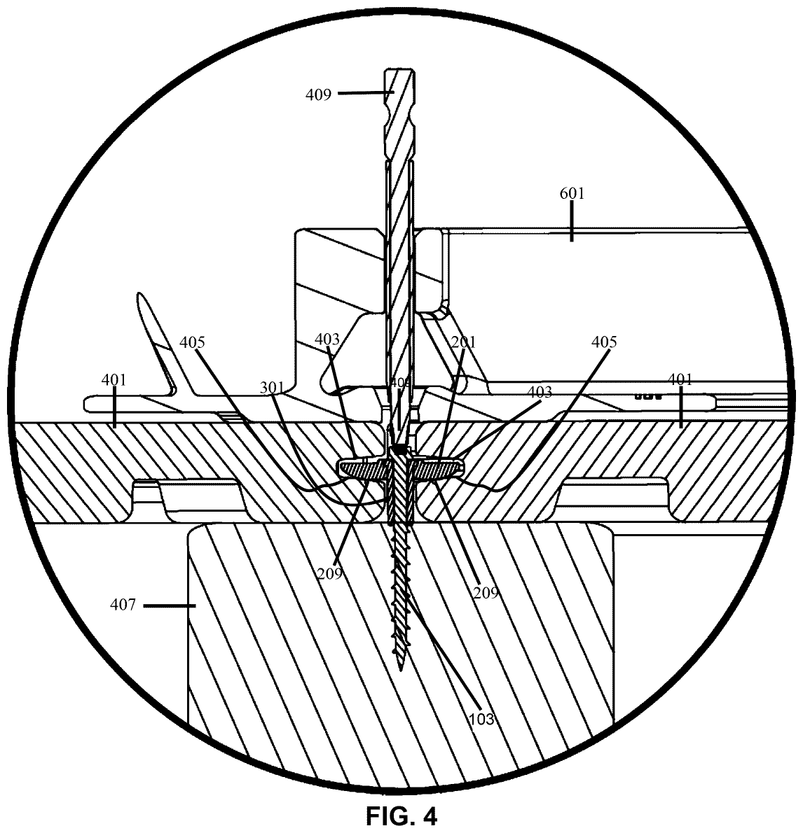

As shown in FIG. 1, when the rotating T-clip assembly (101) is assembled, the collar element (301) is passed through the aperture (214) in the wing element (201), beginning with the end opposite the connecting elements (305), until the connecting elements (305) are received within and held by the retaining elements (216) of the aperture (214). An embodiment of the rotating T-clip assembly (101) in use to affix a pair of adjacent deck boards (401) to a joist (407) is shown in FIG. 4. In the depicted embodiment, a pair of deck boards (401) are placed side-by-side in parallel for installation by affixing them to a joist (407). The adjacent edges of the deck boards (401) are placed next to each other, but spaced apart by about the width of the collar element (301). The edges of the deck boards (401) are supported by the top of the joist (407). The rotating T-clip assembly (101) is intended for use with deck boards (401) which have lateral recesses (403), as shown.

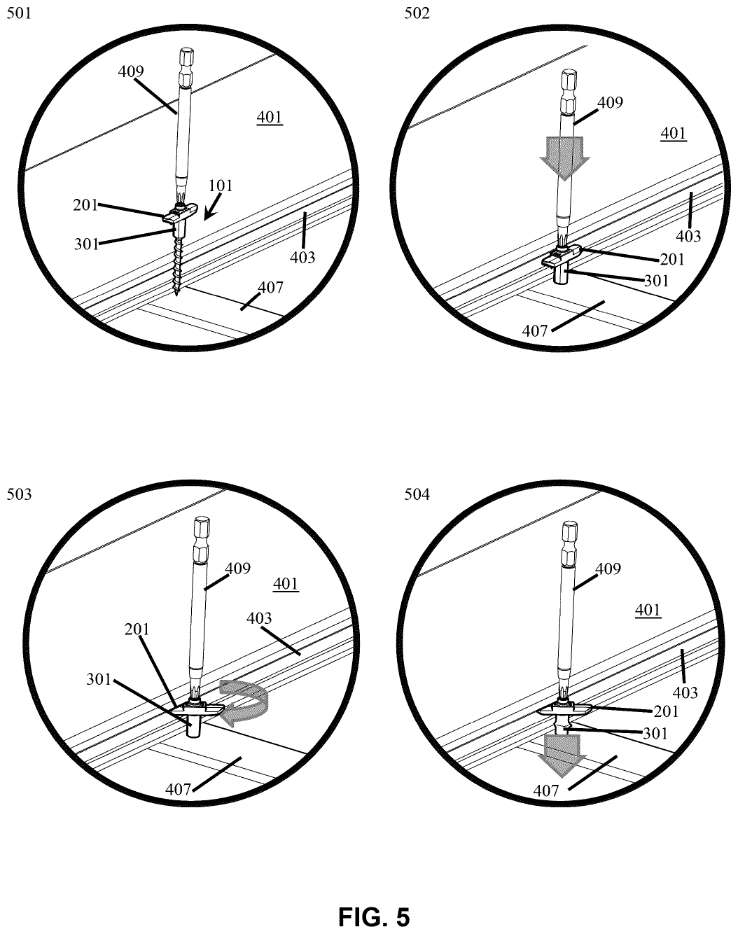

FIG. 5 depicts a method of using a rotating T-clip assembly (101). In (501), the rotating T-clip assembly (101) is shown positioned above the deck boards (401) and the pointed end of the fastener element (103) is descended between the deck boards (401) until it contacts the top of the joist (407). One of the deck boards is omitted from FIG. 5 to allow a clearer view of the method. A driver (409), such as a drill bit, is affixed to the head of the fastener element (103) and rotated to cause the fastener element (103) to advance into the joist (407).

In (502), the wing element (201) is shown oriented (502) lengthwise in alignment with the gap between the deck boards (401) so that as the rotating T-clip assembly (101) descends between the gap, the wing element (201) does not catch on the tops of the deck boards (401). In (503), once the wing element (201) clears the top of the recesses (403), it may spin freely within the recesses (403) as the driver (409) causes the fastener element (103) to further advance into the joist (407) and lowers the rotating T-clip assembly (101). However, this rotational motion will slow and stop when the engaging elements (209) contact the bottom (405) of the recesses (403).

In (504), the sharp points formed by the triangular engaging elements (209) will dig (504) into the material of the recesses (405) and hold the wing element (201) in place. This, combined with the engagement between the fastener element (103) and joist (407), are effective to affix the deck boards (401) to the joist (407) and inhibit significant unwanted movement. This process may be repeated with additional rotating T-clip assemblies (101) as needed along the length of the deck boards (401) where they pass over a joist (407) to affix the deck boards (401) to the structural elements of the deck.

It should be noted that in these depicted embodiments, the total height of the collar element (301) is slightly greater than the distance between the top of the joist (407) and the top of the rotating T-clip assembly (101) after installation. This can be seen in, for example, FIG. 4, which depicts a portion of the bottom of the collar element (301) disposed below the top line of the joist (407). In practice, the collar element (301) may preferably be manufactured from a material too soft for the collar element (301) to significantly penetrate the top of the joist (407) (e.g., a plastic), and, instead, this sizing will result in the collar element (301) becoming deformed and slightly compressed, as shown in step (504), during installation. This is intended, as it allows the collar element (301) to serve a spacing role and to reduce the degree to which the rotating T-clip assembly (101) can be overtightened. While a snug connection is desirable, it is also desirable to allow some degree of play to accommodate changes in ambient conditions which can result in deformations of the joists (407), deck boards (401), the rotating T-clip assembly (101), and other elements. In an embodiment, the joist (407) may compress under the load of the fastener as the teeth are engaged.

A rotating T-clip assembly (101) according to the present disclosure may thus be used to rapidly attach deck boards (401) to joists (407) in sequence.

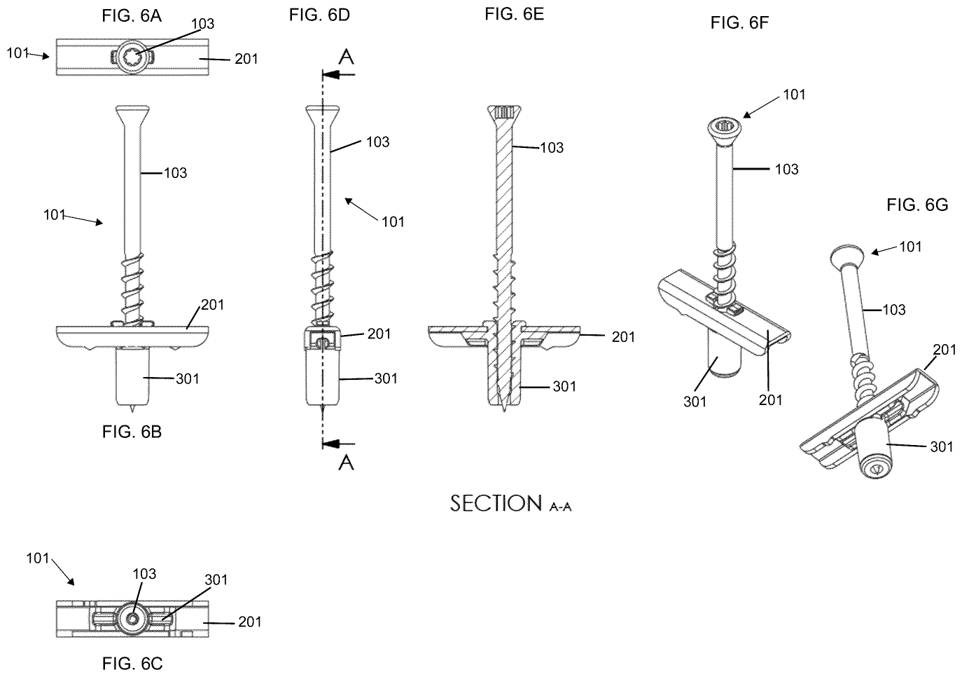

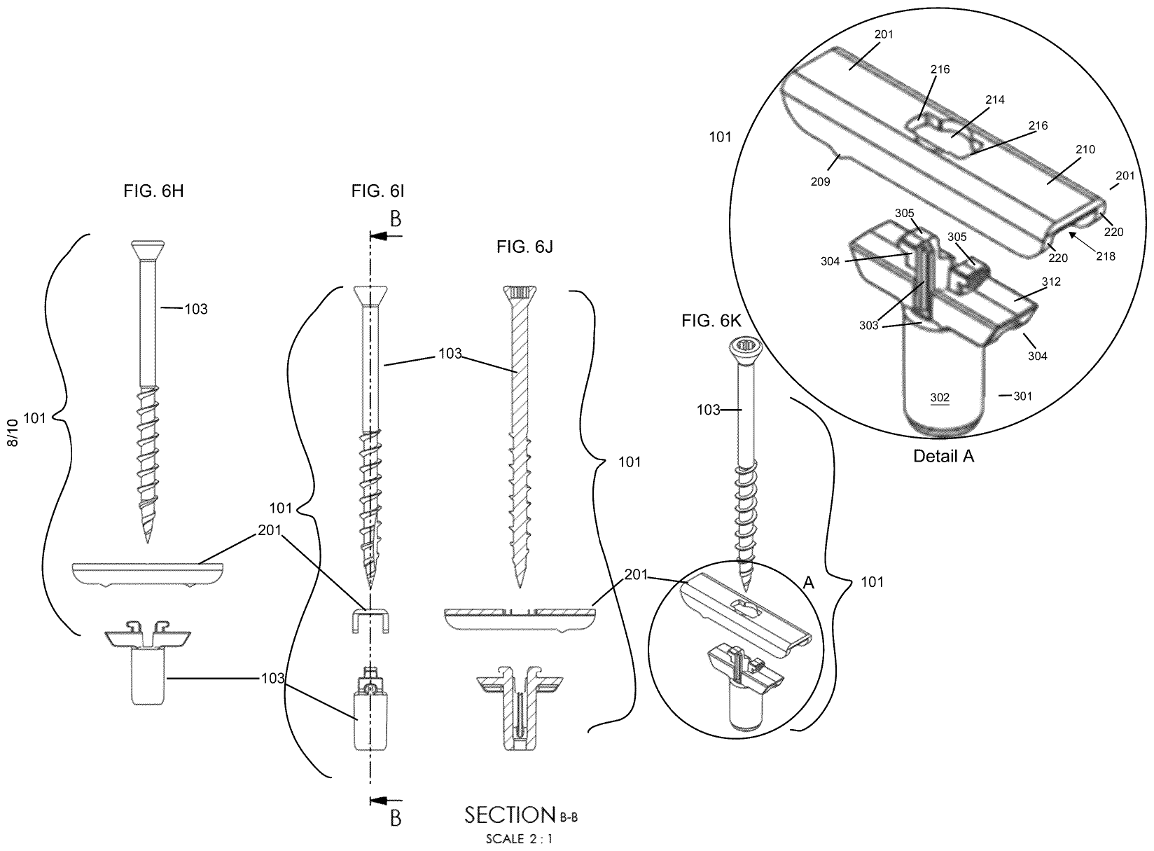

An alternative embodiment of a rotating T-clip assembly (101) according to the present disclosure is depicted in FIGS. 6A, 6B, 6C, 6D, 6E, 6F, and 6G, which provide various assembled elevation and isometric views, and FIGS. 6H, 6I, 6J, and 6K, which provide various exploded elevation and isometric views. The depicted alternative embodiment shares some features with the embodiment, with some differences, some of which are described herein. The depicted alternative embodiment is also comprised of a fastener element (103), a wing element (201) and a collar element (301). However, the depicted alternative embodiment has a different configuration of the wing element (201) and collar element (301).

The depicted alternative wing element (201) is generally in the configuration of a truss, and does not have a visually or structurally distinct main body relative to the wings (210), but rather has a width-wise cross-section generally in the configuration of an upside-down “U.” The “U” is formed by a generally flat, planar top surface (210) and two elongated legs (220) extending generally perpendicularly, and parallel with each other, from opposing sides of the top surface (210) to define a trough (218). The wings (210) in this embodiment extend from opposing sides of a central bore (214).

In this depicted embodiment, the central bore (214) has a generally uniform shape and structure extending through the top surface (210), with the retaining elements (216) comprising notches formed in the outer periphery of the bore (214) at opposing sides, generally coaxial with the major axis of the wing element (201). These retaining elements/notches (216) provide passage for the connecting elements (305) of the collar element (301) and accommodate the arms (303), as described elsewhere herein. This depicted embodiment has a single engaging element (209) on each of the legs (220), disposed at opposing ends of the wing element (201).

This depicted alternative collar element (301) generally comprises a hollow, cylindrical main body (302) which, when the rotating T-clip assembly (101) is assembled, is generally coaxial with the main axis of the bore (214) in the wing element (201). This depicted alternative collar element (301) comprises a truss element (312) affixed to the top of the main body. The structure and shape of the truss element (312) is generally similar to that of the wing element (210), but smaller in certain dimensions, primarily width, so that the collar element (301) can be snapped into the trough (218) of the wing element (201), and the truss-shape of the wing element (201) generally surrounds and holds the truss element (312) of the collar element (301). This arrangement can be seen in, for example, FIGS. 6E and 6G.

The depicted truss element (312) includes a hollow middle (307), contiguous with that of the main body (302), for receiving the fastener element (103). In the depicted embodiment, the collar element (301) comprises a pair of opposing connecting elements (305) affixed to the main body (302) by arms. The depicted arms (303) are not rigidly attached to the truss element (312), but rather can flex inwardly. Thus, when this embodiment of the rotating T-clip assembly (101) is assembled, the connecting elements (305) can be squeezed together and passed through the bore (214), then released to their natural position, where their bottom sides (304) will hold against the top surface (210) of the wing element (201). This can be seen in, for example, FIGS. 6D, 6E, and 6F.

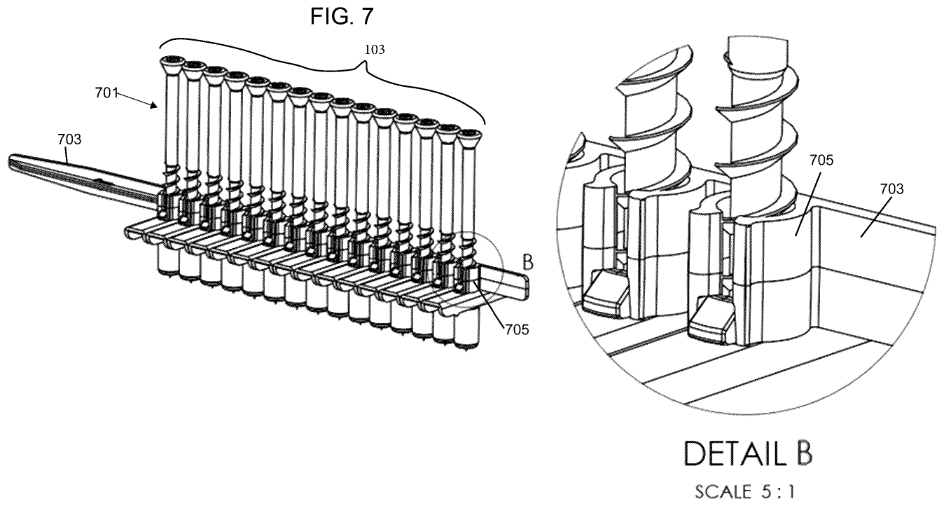

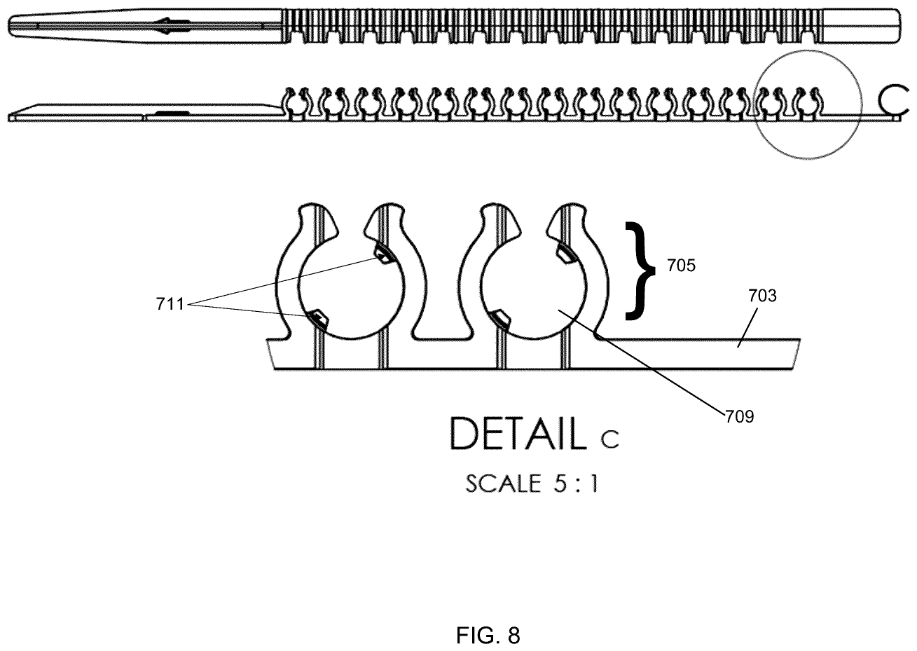

The method of using this depicted embodiment (101) is generally similar to that of the other depicted embodiment. This alternative embodiment (101) may be used by assembling a plurality of rotating T-clip assemblies into a linear clip (701), such as, without limitation, that show in the exemplary embodiments of FIG. 7 and FIG. 8. The clip may be used with an installation tool (601) for faster and more precise installation by not having to select a new unit and reset the install. As can be seen in the depicted embodiment of FIGS. 7-8, the clip (701) preferably holds the rotating T-clip assemblies (101) upright and vertical, which aligns the head of the fastener element (103) for ready driving, and positions the rotating T-clip assembly (101) for proper installation. Also, each rotating T-clip assembly (101) is preferably evenly spaced in the clip (701) for consistent and reliable installation, and to improve and simplify the design, and consistency of an associated install tool. It is also preferable that the clip (701) hold the wing elements (201) at a consistent angle, preferably parallel to each other, and preferably perpendicular to the direction of collation. The clip (701) also preferably prevents each rotating T-clip assembly (101) from rotating until it has disengaged from the clip (701).

FIG. 8 depicts an exemplary embodiment of a clip (701) according to the present disclosure. In this depicted embodiment, the clip (701) comprises a backing strip (703), generally in the configuration of an elongated, flat element, preferably made from a flexible material capable of deformation and returning to its natural shape. As shown, the backing strip (703) has attached thereto along one side a sequence of holding elements (705), each configured to retain a rotating T-clip assembly (101).

The depicted holding elements (705) are generally in the configuration of a partial ring, open circle, or a roughly horseshoe-like shape. That is, the holding elements (705) are generally circular, with a small section of material missing opposite the point where the holding element (705) is affixed to the backing strip (703). This opening allows a rotating T-clip assembly (101) to be inserted into and removed from the open middle (709) of the holding element (705) to be held there. Because the material is capable of flexible deformation, the holding element (705) can deform to receive a rotating T-clip assembly (101) and return to its natural shape to hold. In the depicted embodiment, the interior surface of the holding element (705) may comprise additional elements to assist with retention, such as small tabs (711), as shown in FIG. 8.

An advantage of the rotating T-clip (101) described herein is removability. After construction is complete, deck boards (401) may become damaged or may otherwise require replacement. The design of the rotating T-clip (101) described herein has the advantage of reversibility. A driver bit may be descended between deck boards (401) to engage and reverse the fastener (103), withdrawing it from the joist (407). Without the fastener element (103) holding the deck boards (401) to the joists (407), the deck boards (401) can be lifted and disengaged from the rotating T-clip (101) for easy removal and repair, and without damaging adjacent components or structures. The rotating T-clip (101) can then be either re-used or replaced.

Throughout this disclosure, geometric terms may be used to characterize, among other things, sizes, shapes, dimensions, angles, distances, and relationships. These terms may be used with qualifiers such as “generally,” “about,” and “approximately.” One of ordinary skill in the art will understand that, in the context of this disclosure, these terms are used to describe a recognizable attempt to conform a device or component to the qualified term. By way of example and not limitation, components described as being “generally coplanar” will be recognized by one of ordinary skill in the art to not be actually coplanar in a strict geometric sense because a “plane” is a purely geometric construct that does not actually exist and no component is truly “planer,” nor are two components ever truly coplanar. Variations from geometric descriptions are unavoidable due to, among other things, manufacturing tolerances resulting in shape variations, defects, imperfections, non-uniform thermal expansion, natural wear, minor variations that are nevertheless recognizable as the qualified term, and other deformations. One of ordinary skill in the art will understand how to apply geometric terms, whether or not qualified by relative terms such as “generally,” “about,” and “approximately,” to describe a reasonable range of variations from the literal geometric term in view of these and other considerations appropriate to the context. Additionally, the use of the conjunctive and disjunctive should not necessarily be construed as limiting, and the conjunctive may include the disjunctive, and vice versa.

The inventors are aware of the normal precepts of English grammar. Thus, if a noun, term, or phrase is intended to be further characterized, specified, or narrowed in some way, such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain and ordinary English meaning to those skilled in the applicable arts as set forth above.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A rotating T-clip comprising:
a fastener element;
a wing element comprising:
a pair of opposing wings extending outwardly from a center thereof; and
a vertical bore extending generally perpendicularly and centrally from a top side to an opposing bottom side of said wing element; and
a collar element comprising:
a main body; and
a pair of connecting elements, each of said connecting elements affixed to said main body via an arm.

2. The rotating T-clip of claim 1, wherein said top surface is generally flat.

3. The rotating T-clip of claim 2, wherein said vertical bore comprises a pair of opposing retaining elements disposed on an utter periphery thereof.

4. The rotating T-clip of claim 3, wherein said retaining elements comprise recesses.

5. The rotating T-clip of claim 4, wherein said wing element has a cross-section generally in the configuration of an upside-down U-shape.

6. The rotating T-clip of claim 5, wherein said bottom edge of said wing element tapers upward toward said top surface at opposing distal ends.

7. The rotating T-clip of claim 6, wherein each of said wings is generally symmetric across a major axis of said wing element.

8. The rotating T-clip of claim 7, wherein said wings are generally colinear along said major axis.

9. The rotating T-clip of claim 8, wherein said each of said wings comprises at least one engaging element.

10. The rotating T-clip of claim 9, wherein said engaging element comprises a generally triangular tooth.

11. The rotating T-clip of claim 10, wherein said each of said teeth protrudes from said bottom edge.

12. The rotating T-clip of claim 11, wherein said main body of said collar element is generally in the configuration of a hollow cylinder.

13. The rotating T-clip of claim 12, wherein said hollow cylinder has an outer diameter less than an inner diameter of said vertical bore.

14. The rotating T-clip of claim 13, wherein said hollow cylinder has a pair of opposing truncated chords on an outer surface.

15. The rotating T-clip of claim 14, wherein said connecting elements are generally in the configuration of an inverted L-shape.

16. The rotating T-clip of claim 15, wherein said connecting elements extend radially outward from a central axis of said collar element.

17. The rotating T-clip of claim 16, wherein said arms are connecting elements extending radially outward from a central axis of said collar element.

18. The rotating T-clip of claim 17, wherein said rotating T-clip is in an assembled configuration.

19. The rotating T-clip of claim 18, wherein, in said assembled configuration, said portion of each of said connecting elements is received within and held by one of said retaining elements and a second portion of each of said connecting elements is braced against said top surface.

20. A clip strip comprising a plurality of said rotating T-clips of claim 19 removably disposed on a linear backing.
